(19) United States
(12) Patent Application Publication
(10) Pub. No.: US 2023/0370849 A1
(43) Pub. Date: Nov. 16, 2023

(54) NFC DEVICE ACTIVATION FOR TEAMS

(71) Applicant: POPL CO., Los Angeles, CA (US)

(72) Inventor: Jason Dean Alvarez-Cohen, Los Angeles, CA (US)

(73) Assignee: POPL CO., Los Angeles, CA (US)

(21) Appl. No.: 18/312,495

(22) Filed: May 4, 2023

Related U.S. Application Data
(60) Provisional application No. 63/341,372, filed on May 12, 2022.

(51) Int. Cl. H04W 12/47; H04W 12/06

(52) U.S. Cl. CPC H04W 12/47; H04W 12/06

(57) ABSTRACT

In some aspects, an activation computing device may capture an image containing a visual credential that is displayed on a screen of a credential computing device. The activation computing device may extract, from the visual credential, an activation link associated with a first profile. The activation computing device may retrieve data associated with the first profile from an profile database. The activation computing device may retrieve a near-field communication device (NFC) identifier from a respective NFC device. The activation computing device may associate the first profile with the near field communication (NFC) device identifier. Numerous other aspects are described.

### CROSS-REFERENCE TO RELATED APPLICATION

This application claims priority to U.S. Provisional Patent Application Ser. No. 63/341,372, filed on May 12, 2022, entitled “NFC DEVICE ACTIVATION FOR TEAMS,” which is hereby incorporated by reference in its entirety for all purposes.

### BACKGROUND OF THE INVENTION

Near-field communication devices (NFC) devices can allow for the quick exchange of contact information. However, associating contact information with NFC devices can be cumbersome and this is particularly true when several devices are set up for different individuals or organizations. Accordingly, improvements in associating NFC devices with contact information are desirable.

### BRIEF SUMMARY OF THE INVENTION

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, techniques disclosed herein may include capturing, by a camera of an activation computing device, an image containing a visual credential that is displayed on a screen of a credential computing device. The techniques may also include extracting, by the activation computing device and from the visual credential, an activation link associated with a first profile. Method may furthermore include retrieving, by the activation computing device via the activation link, data associated with the first profile from a profile database. The techniques may in addition include retrieving, by the activation computing device, a near-field communication (NFC) device identifier from a near-field communication (NFC) device. The techniques may moreover include associating, by the activation computing device, the first profile with the near-field communication (NFC) device identifier. The techniques may include corresponding computer-implemented methods, computer systems, apparatus, and computer programs recorded on one or more computer storage devices, each configured to perform the actions of the techniques.

Implementations may include one or more of the following features. Techniques where the activation computing device performs the associating by instructing the profile database to associate the first profile and the near-field communication (NFC) device identifier. Techniques where extracting the activation link associated with the first profile may include: translating information having the activation link from a first data format to a second data format. Techniques where associating the first profile further may include: reading, by the activation computing device, an unique identifier from the near-field communication (NFC) device; and transmitting, by the activation computing device, a request for the profile database to associate the first profile with the unique identifier, the request transmitted to the profile database. Techniques may include: transmitting, by the activation computing device, a request for the profile database to associate the unique identifier with a second profile, the request transmitted to the profile database. Techniques where the visual credential is at least one of a linear barcode or a matrix barcode. Techniques where the activation computing device is a mobile device. Techniques where the activation link is a deep link that identifies a location within a mobile application. Implementations of the described techniques may include hardware, a method or process, or a computer tangible medium.

### BRIEF DESCRIPTION OF THE DRAWINGS

FIG. 1 is a simplified diagram showing a credential computing device displaying user profiles according to at least one embodiment;

FIG. 2 shows a simplified diagram of a credential computing device and an activation computing device according to at least one embodiment;

FIG. 3 shows a simplified flowchart of a process for retrieving profile data using a visual credential according to at least one embodiment;

FIG. 4 shows a simplified diagram of an activation computing device activating a near field communication (NFC) device according to at least one embodiment;

FIG. 5 shows a simplified flowchart of a process for writing profile data to a NFC device according to at least one embodiment;

FIG. 6 shows a simplified diagram of a credential computing device and an activation computing device according to at least one embodiment and

FIG. 7 is a simplified flowchart of a process for associating a device with a profile according to at least one embodiment.

FIG. 8 is a simplified flowchart of a process for activating NFC devices according to at least one embodiment.

FIG. 9 is an exemplary computing system according to at least one embodiment.

### DETAILED DESCRIPTION OF THE INVENTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

In order to better appreciate the features and aspects of the present disclosure, further context for the disclosure is provided in the following section by discussing one particular implementation of a process for activating NFC-enabled devices, according to embodiments of the disclosure. These embodiments are for explanatory purposes only and other suitable processes and variations are within the scope of this disclosure.

Digital business cards can facilitate both business and social networking. These cards, like physical business cards, allow someone to share contact information with a new acquaintance. Business cards both create a quick first impression on the recipient and share necessary information. However, unlike physical business cards which may be misplaced or forgotten, a digital business card can instantaneously add a new contact, with all of the appropriate information, onto a recipient's mobile device.

In addition to providing contact information, digital business cards can include functionality that can help create a positive impression with a new acquaintance. For example, a digital business card can cause a recipient's phone to link to a company web site or trigger a product demonstration video on a specific website page. In addition, the digital business card can send a recipient directly to a specific location in an application on a mobile device, and this functionality can be enabled using deep linking. Deep links can include mobile deep linking (e.g., a Uniform Resource Identifier (URI) that points to a specific application) or web deep linking (e.g., a hyperlink that points to a specific piece of web content on a website).

Digital business cards can be enabled using near-field communication (NFC) techniques. NFC communication can allow a first NFC enabled device, such as a smartphone, smartwatch, tablet computer, NFC enabled wristband, NFC enabled token, or any other NFC enabled computing device, to share a digital business card with a second NFC enabled device. For instance, two scientists, who met at a conference and have discussed a future research collaboration, can tap NFC enabled smartphones to mutually exchange digital business cards.

Activating digital business cards can include associating a unique identifier from an NFC enabled device with a profile hosted by at least one of a digital business card provider, a website, or an application. This activation process can include using visual credentials to cause the credential computing device to instruct a profile database to associate the unique identifier and the profile in the database. For example, a plurality of users can each be associated with a respective unique NFC-enabled device with a single operator. The user can access a list of profiles using a personal computer (e.g., credential computing device). Once the user selects a profile, a visual credential can be presented on the computer's display screen. The user can read the visual credential, in this case a quick response (QR) code, using a camera and software on a mobile phone (e.g., activation computing device). The mobile phone can open a software application to the profile after reading the visual credential. The user can then tap the mobile phone to one or more NFC devices to associate the devices with the profile. This process can be expeditiously repeated for any number of profiles, enabling a single operator to activate a plurality of NFC-enabled devices for a plurality of users.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

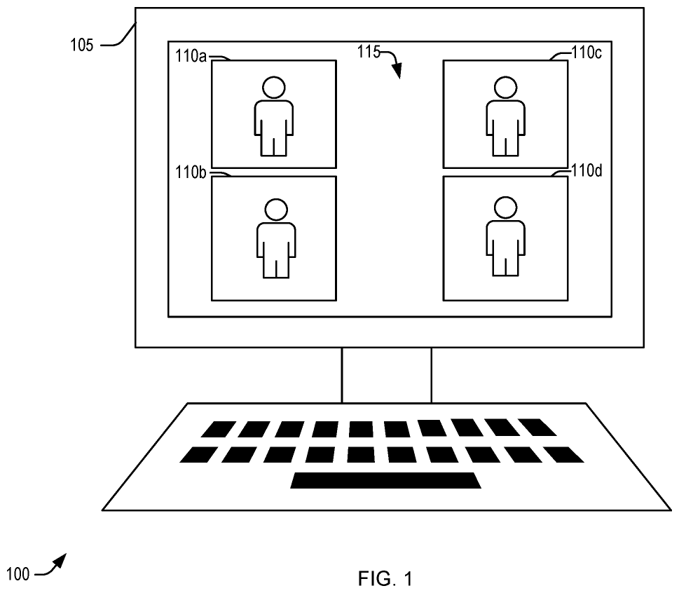

FIG. 1 is a simplified diagram 100 showing a credential computing device 105 displaying a plurality of user profiles 110a, 110b, 110c, 110d, according to at least one embodiment of the disclosure. Credential computing device 105 can be a personal computer, a laptop computer, a mobile device such as a tablet or smartphone, a virtual machine, a bare metal machine or other suitable electronic device. A user can log into an account via credential computing device 105 causing the computing device to display a plurality of user profiles 110a, 110b, 110c, 110d. Computing device 105 can display user profiles 110a, 110b, 110c, 110d on a display device 115. Display device 115 can be any suitable display that can display content generated by credential computing device 105 via a wired or wireless connection (e.g., liquid crystal display (LCD), light emitting diodes (LED) display, etc.).

Each user profile 110a, 110b, 110c, 110d can be associated with a particular entity (e.g., person), however, in other embodiments each profile can be associated with a group of people, an organization, a corporation, etc. In some embodiments each user profile 110a, 110b, 110c, 110d can contain information about the associated entity (e.g., contact information such as an address, a phone number, an employer, a website, an email, a date of birth, a user profile, an identification (ID) card number, a professional license, or other information). In various embodiments, each user profile 110a, 110b, 110c, 110d can also be linked to one or more social media accounts for the associated entity (e.g., user profiles for social media sites such as, for example, LinkedIn, Facebook, Instagram, Snapchat, etc.).

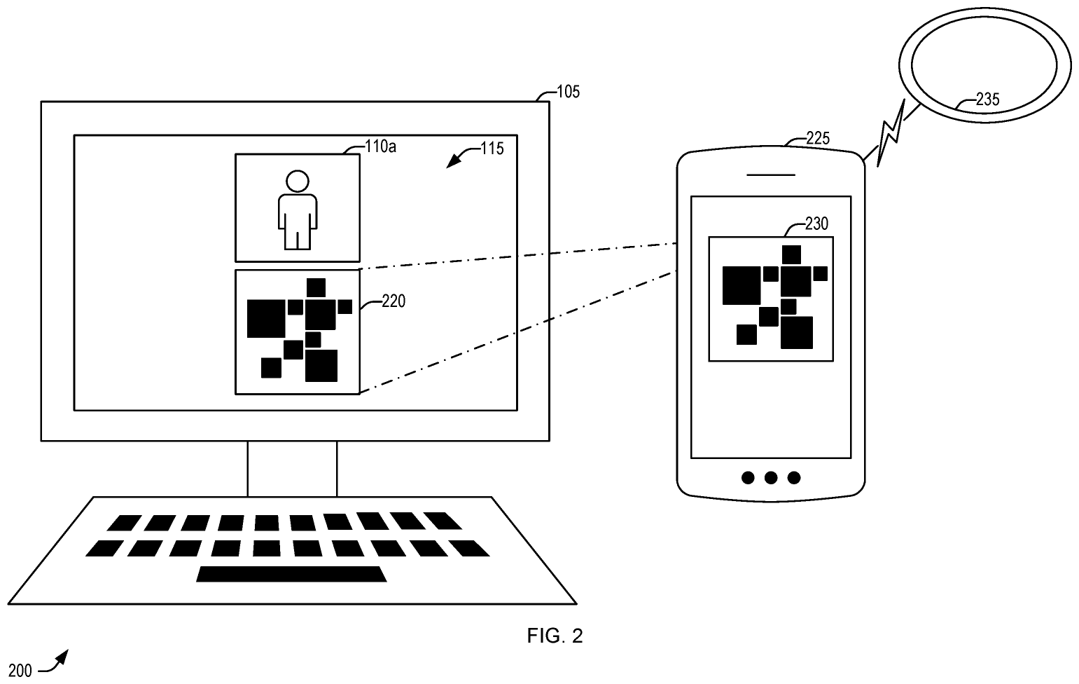

FIG. 2 shows a simplified diagram 200 of the credential computing device 105 interacting with an activation computing device 225, according to at least one embodiment of the disclosure. The credential computing device 105 is the same credential computing device shown in FIG. 1, however in FIG. 2 the credential computing device is displaying a credential 220 for a particular profile (e.g., profile 110a). For example, credential 220 can be shown on display device 115 when a user selects a particular profile (e.g., profile 110a shown in FIG. 1). Credential 220 can be a visual credential such as a quick response (QR) code, IQR code, Frame QR, HCCD2D code, JAB code, linear barcode, matrix barcode or any other suitable type of optically coded information.

Activation computing device 225 can receive the credential 220 from credential computing device 204. In one embodiment a camera (not shown in FIG. 2) within activation computing device 225 can capture an image 230 of the credential 220. In response to capturing the image 230, the activation computing device 225 can extract an activation link encoded in the credential 220. Activation computing device 225 can utilize the activation link to access data associated with the selected profile (e.g., profile 110a). Activation computing device 225 can then be used to associate profile 110a to a particular NFC-enabled device 235.

In one embodiment, after the activation computing device 225 has accessed data associated with a particular user profile, the NFC-enabled device 235 can be brought within an appropriate proximity of the computing device 225 so the computing device can receive a unique ID from the NFC-enabled device. An appropriate proximity can be 0.1 millimeter (mm), 0.5 mm, 1 mm, 2 mm, 3 mm, 5 mm, 10 mm, 15 mm, 20 mm, 30 mm, 40 mm, 50 mm, 75 mm, 100 mm, 200 mm, 300 mm, 400 mm, 500 mm, 600 mm 700 mm, 800 mm, and the like. In response to receiving the unique ID, the activation computing device can associate that unique ID with the selected user profile (e.g., profile 110a). In some embodiments the association can be performed by assigning the unique ID to the user profile in a database containing a list of profiles, where the unique ID is added to the user profile's “associated devices” field in the database. However, other suitable processes can be used, as described in more detail below. Once the association is complete, the NFC-enabled device 235 can direct an electronic device that reads the unique ID to data associated with the user profile (e.g., profile 110a).

Using this process a plurality of NFC devices 235 can be expediently associated with a respective user account for each device. A user can select an appropriate user profile, then use the activation computing device 225 to take an image of the unique credential and receive the unique ID from a particular NFC-enabled device 235 to perform the association.

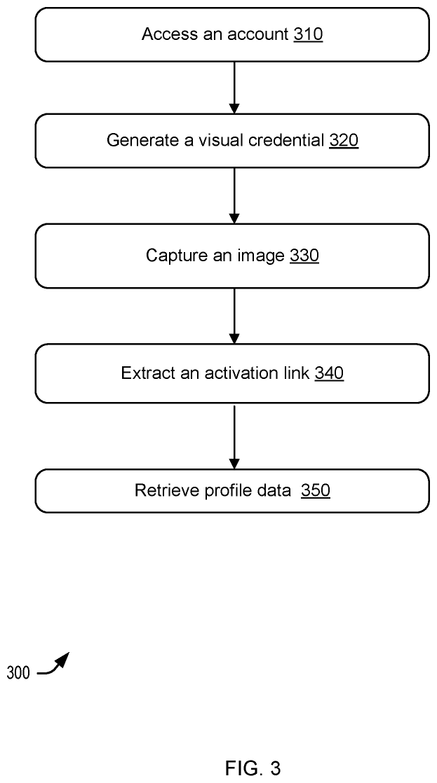

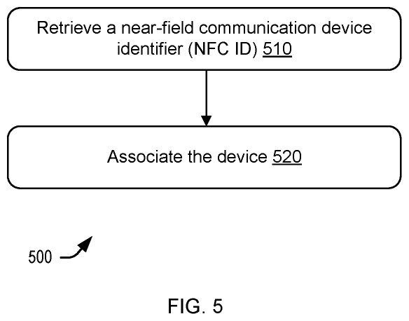

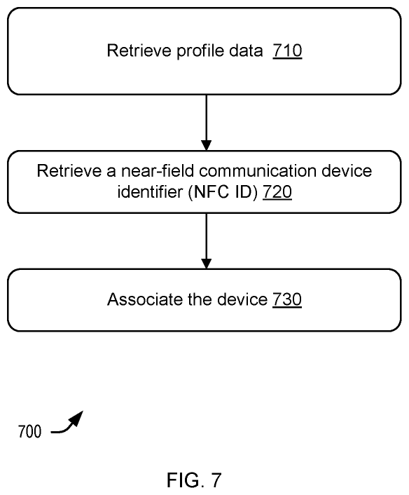

FIG. 3 shows a simplified flowchart of a process 300 for retrieving account data using a visual credential according to at least one embodiment of the disclosure. This process, along with the process disclosed in relation to FIGS. 5 and 7, is illustrated as a logical flow diagram, each operation of which can be implemented in hardware, computer instructions, or a combination thereof. In the context of computer instructions, the operations may represent computer-executable instructions stored on one or more computer-readable storage media that, when executed by one or more processors, perform the recited operations. Generally, computer-executable instructions include routines, programs, objects, components, data structures and the like that perform particular functions or implement particular data types. The orders in which the operations are described are not intended to be construed as a limitation, and any number of the described operations can be combined in any order and/or in parallel to implement the processes or the method.

Turning to process 300 in greater detail, at block 310, an account can be accessed. The account can be a user account or administrative account for a website or social media platform. A credential computing device (e.g., credential computing device 105, credential computing device 105, etc.) can be used to access the account via a user interface.

At block 320, a visual credential can be generated. A credential computing device (e.g., credential computing device 105) can generate the credential locally or the credential computing device can retrieve the visual credential from storage (e.g., hard disk drive (HDD), solid state drive (SSD), cloud storage, etc.). The visual credential can be retrieved by the credential computing device, or provided to the credential computing device, from a separate computing device.

The visual credential can contain an activation link that is associated with the profile. The activation link can be a uniform resource locater (URL), a deep link, a hyperlink or any other suitable link. A deep link can be a link that points to a mobile application or a particular page in a mobile application using a Uniform Resource Identifier (URI). The visual credential can be a bar code, IQR code, Frame QR, HCCD2D code, JAB code, linear barcode, matrix barcode or any other suitable type of optically coded information. For example, in one embodiment the visual credential may be a particular series of numbers, text information, web address, web link or any other information that can be received by the activation computing device, as explained in more detail herein. The visual credential can provide a code that can be used to retrieve the activation link from a database (e.g., numeric code, alphanumeric code, public key, etc.).

At block 330, an image can be captured. The image can be captured by a camera within an activation computing device (e.g., activation computing device 225, etc.). In other embodiments the image can be captured by a camera that is part of a separate computing device and provided to the activation computing device (e.g., activation computing device 225, etc.). The captured image may be provided to the activation computing device by a local area network, a wide area network, a personal area network (e.g., Bluetooth), a near-field communication connection, and the like.

At block 340, an activation link can be extracted. Information encoding the activation link can be extracted from a visual credential, such as a QR code, using software including a mobile operating system (e.g., Android 8.0-12.0, iOS 11.0-15.0, etc.) or specialized software (e.g., QReader, etc.). The activation link can be a uniform resource locator (URL), hyperlink, deeplink, etc. In some circumstances, the activation link can be provided without a visual credential. For instance a credential computing device can provide the activation link via wireless communication such as near field communication (NFC), Bluetooth, WiFi, etc.

At block 350, the profile data can be retrieved, or accessed. The activation link can be used to retrieve the profile from a remote server, or access the profile that is resident on a separate computing device (e.g., server). The profile data can include names, addresses, phone numbers, email addresses, websites, professional credentials, companies, social media profiles, etc. that are associated with the profile.

One of ordinary skill, with the benefit of this disclosure, would recognize many variations, modifications, and alternatives. It will be appreciated that process 300 is illustrative and that variations and modifications are possible. Steps described as sequential may be executed in parallel, order of steps may be varied, and steps may be modified, combined, added or omitted. One or more of the steps from process 300 can be performed by a computing device such as computer system 910 disclosed below.

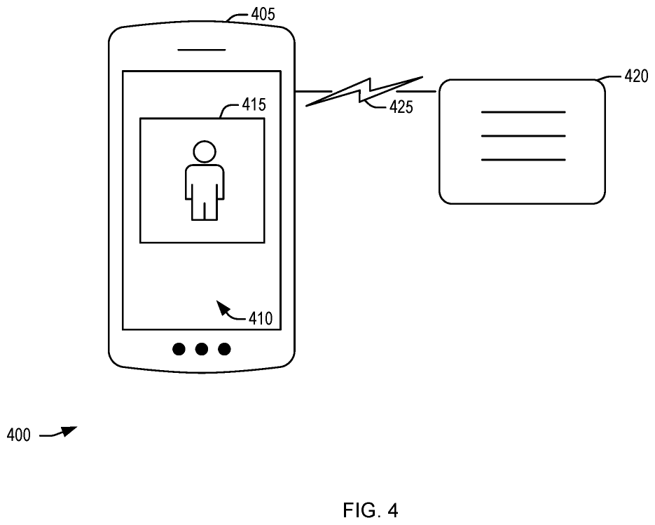

FIG. 4 shows a simplified diagram 400 of an activation computing device 405 activating a near field communication (NFC) enabled device 420. The activation computing device 405 can be a computing device that is capable of reading and/or writing to an NFC device. In some embodiments, the activation computing device 405 can be a mobile device such as a smartphone, a tablet, a smartwatch, etc. A screen 410 on activation computing device 405 can display a profile 415, and data associated with the profile can be written to an NFC-enabled device 420. Any device that can communicate using one of the NFC protocols can be an NFC-enabled device 420. NFC protocols include ISO/IEC 18092/ECMA-340—Near Field Communication Interface and Protocol-1 (NFCIP-1); ISO/IEC 21481/ECMA-352—Near Field Communication Interface and Protocol-2 (NFCIP-2), etc. Activation computing device 405 can read data from NFC-enabled device 420 or write data to NFC device enabled 420 via wireless communication 425. Wireless communication 425 can occur via an NFC communication protocol, a Bluetooth communication, WiFi, etc.

FIG. 5 shows a simplified flowchart of a process 500 for associating profile data to an NFC device. Turning to process 500 in greater detail, at block 510, a near field communication identifier (NFC ID) can be retrieved. The NFC ID can be retrieved from NFC-enabled device 420 by activation computing device 405 via wireless communication 425.

At block 520, the device can be associated with a profile. The device can be an NFC device (e.g., NFC-enabled device 420). Activation computing device 405 can associate NFC-enabled device 420 by adding the retrieved NFC ID to a database and linking the NFC ID to one or more profiles (e.g., via a pointer, etc.). In some embodiments, activation computing device 405 can associate NFC-enabled device 420 with a profile by writing an activation link to NFC-enabled device 420 via wireless communication 425 where the activation link will direct an electronic device to data associated with the profile.

One of ordinary skill, with the benefit of this disclosure, would recognize many variations, modifications, and alternatives. It will be appreciated that process 500 is illustrative and that variations and modifications are possible. Steps described as sequential may be executed in parallel, order of steps may be varied, and steps may be modified, combined, added or omitted. One or more of the steps from process 500 can be performed by a computing device such as computer system 910 disclosed below.

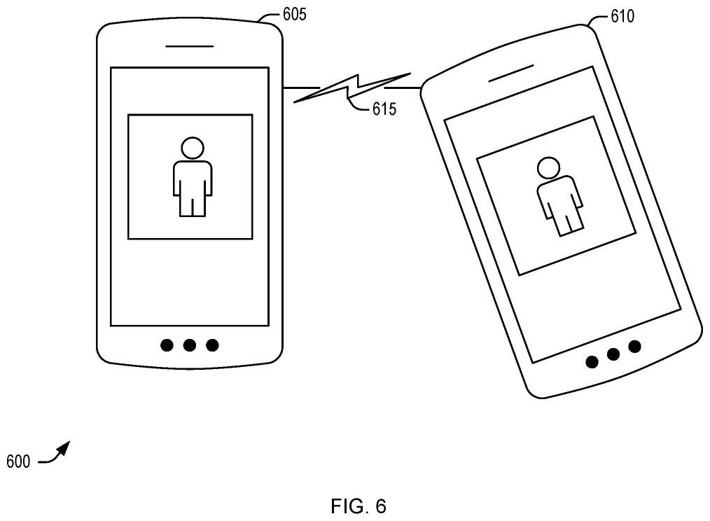

FIG. 6 shows a simplified diagram 600 of a credential computing device 605 and an activation computing device 610, according to at least one embodiment of the disclosure. Credential computing device 605 can be any device that can communicate with activation computing device 610. For instance, credential computing device 605 can communicate via a wireless connection 615 or a wired connection. Wireless connection 615 can include NFC, WiFi, Bluetooth, etc. In some embodiments, credential computing device 605 can communicate with activation computing device 610 via a network (e.g., the Internet). In some circumstances, the credential computing device can be a server computer such as a virtual machine or a bare machine.

Activation computing device 610 can be a device that is capable of reading or writing to a NFC tag. In some circumstances, activation computing device 610 and credential computing device 605 can be the same type of device. Either activation computing device 610 or credential computing device 605 can be mobile devices including a personal computer, a cellular phone, a smartwatch, a tablet, a smartphone, etc. In some circumstances, a computing device can be both the credential computing device and the activation computing device. A single computing device can be used to access an account, retrieve profile data, and associate one or more NFC devices with the retrieved profile.

FIG. 7 is a simplified flowchart of a process 700 for associating a device with a profile according to at least one embodiment. In process 700 the credential computing device and the activation computing device are the same unitary device.

At block 710, the profile data can be retrieved. In some embodiments a user may retrieve the profile data by selecting a particular user profile displayed on the activation computing device. The profile data can be data associated with a profile (e.g., profiles 110a, 110b, 110c, 110d, 110a, 415, etc.). The profile can be associated with one or more persons, a company, an organization, etc. The profile data can include contact information associated with the account. The contact information can include, for example, links to one or more social media accounts associated with the profile, one or more related profiles, phone numbers, physical addresses, email addresses, websites, professional credentials, educational history, employment history, birthdays associated with the account, companies, organizations, languages spoken by individuals associated with the account, etc.

At block 720, a near-field communication device identifier (NFC ID) can be retrieved. The NFC ID can be retrieved using an NFC reader, and the NFC reader can be part of the activation computing device. In some circumstances, the NFC ID may be provided to the activation computing device (e.g., provided via a network, provided manually via a user interface, etc.).

At block 730, the device can be associated. The device can be associated with a profile, and, for instance, the device can be associated with a profile from block 730. The device can be a NFC device, and a NFC device can be a device that can provide information to a NFC reader (e.g., NFC tag, NFC wrist band, NFC business card, mobile device, smartphone, smartwatch, etc.). In some circumstances, the device can be associated by linking the NFC ID to the profile in a database. For example, the activation computing device can access a database containing a list of profiles and add the NFC ID to the profile's “associated devices” field in the database. In some circumstances, the activation computing device can associate the device by writing the activation link or profile data to the NFC device. In some circumstances, the NFC device can be associated with a different profile by selecting the device, via a user interface provided by an application or website, and choosing a new associated profile (e.g., by selecting a profile from a list of profiles, by changing an entry in the database, etc.).

One of ordinary skill, with the benefit of this disclosure, would recognize many variations, modifications, and alternatives. It will be appreciated that process 700 is illustrative and that variations and modifications are possible. Steps described as sequential may be executed in parallel, order of steps may be varied, and steps may be modified, combined, added or omitted. One or more of the steps from process 700 can be performed by a computing device such as computer system 910 disclosed below.

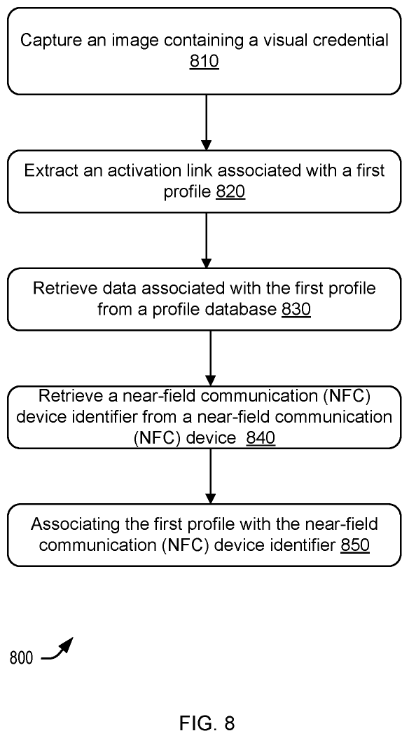

FIG. 8 is a simplified flowchart of a process 800 for activating NFC devices according to at least one embodiment. Turning to process 800 in greater detail, at block 810, an image containing a visual credential can be captured. The visual credential (e.g., visual credential 220) can be a linear barcode, or a matrix barcode such as a quick response (QR) code. The visual credential can be captured by a computing device's camera, and, for example, a mobile device's camera (e.g., a camera of activation computing device 225) can be used to capture the image with the visual credential. The image may be displayed on the screen of a computing device such as credential computing device 105.

At block 820, an activation link associated with a first profile can be extracted from the visual credential from 810. Extracting the visual credential can be performed by transforming the information encoded in the visual credential from a first format to a second format. For example, the information can be transformed from a machine-readable visual format that a human cannot practically read to an alphanumerical format that a human can read. The activation link can be a deep link that points to a specific location in a website or a specific location in an application.

At block 830, data associated with the first profile from 820 can be retrieved from a profile database. Retrieving the data associated with the first profile may include sending a request from the activation computing device to a profile database. In some embodiments, the data associated with the first profile may be retrieved from multiple databases.

At block 840, a near-field communication (NFC) device identifier can be retrieved from a near-field communication (NFC) device. Retrieving the near-field communication (NFC) identifier can include reading a unique identifier (e.g., NFC ID) from the near-field communication (NFC) device (e.g., a near-field communication (NFC) enabled device; NFC-enabled device 235 NFC-enabled device 420).

At block 850, the first profile from 820 can be associated with the near-field communication (NFC) device identifier from 840. Associating the first profile can include instructing the profile database to associate the first profile and the near-field communication (NFC) identifier in the profile database. For example, the activation computing device can transmit a request for the profile database to associate the first profile with the near-field communication (NFC) identifier to the profile database. The first profile can be associated with multiple near-field communication (NFC) identifiers at any one time, and the near-field communication (NFC) identifier may be associated with multiple profiles at any one time.

One of ordinary skill, with the benefit of this disclosure, would recognize many variations, modifications, and alternatives. It will be appreciated that process 700 is illustrative and that variations and modifications are possible. Steps described as sequential may be executed in parallel, order of steps may be varied, and steps may be modified, combined, added or omitted. One or more of the steps from process 800 can be performed by a computing device such as computer system 910 disclosed below.

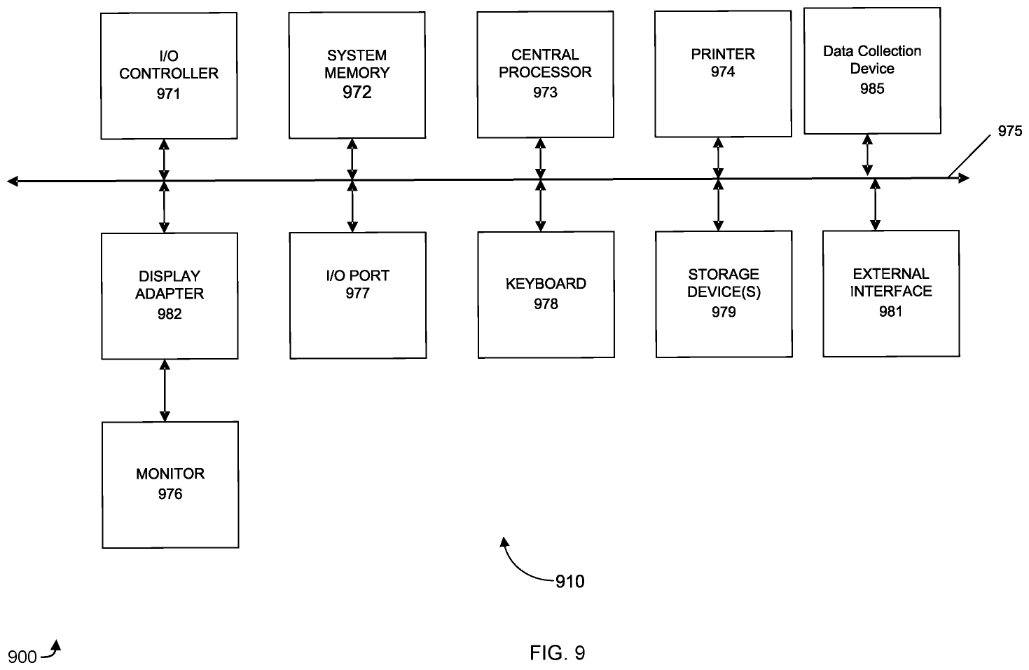

Any of the computer devices or systems mentioned herein may utilize any suitable number of subsystems. Examples of such subsystems are shown in FIG. 9 in computer system 910. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 9 are interconnected via a system bus 975. Additional subsystems such as a printer 974, keyboard 978, storage device(s) 979, monitor 976 (e.g., a display screen, such as an LED), which is coupled to display adapter 982, and others are shown. Peripherals and input/output (I/O) devices, which couple to I/O controller 971, can be connected to the computer system by any number of means known in the art such as input/output (I/O) port 977 (e.g., USB, FireWire®). For example, I/O port 977 or external interface 981 (e.g. Ethernet, Wi-Fi, etc.) can be used to connect computer system 910 to a wide area network such as the Internet, a mouse input device, or a scanner. The interconnection via system bus 975 allows the central processor 973 to communicate with each subsystem and to control the execution of a plurality of instructions from system memory 972 or the storage device(s) 979 (e.g., a fixed disk, such as a hard drive, or optical disk), as well as the exchange of information between subsystems. The system memory 972 and/or the storage device(s) 979 may embody a computer readable medium. Another subsystem is a data collection device 985, such as a camera, microphone, accelerometer, and the like. Any of the data mentioned herein can be output from one component to another component and can be output to the user.

A computer system can include a plurality of the same components or subsystems, e.g., connected together by external interface 981, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g. an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such devices. In addition, the order of operations may be re-arranged. A process can be terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

The specific details of particular embodiments may be combined in any suitable manner without departing from the spirit and scope of embodiments of the disclosure. However, other embodiments of the disclosure may be directed to specific embodiments relating to each individual aspect, or specific combinations of these individual aspects.

The above description of example embodiments of the present disclosure has been presented for the purposes of illustration and description. It is not intended to be exhaustive or to limit the disclosure to the precise form described, and many modifications and variations are possible in light of the teaching above.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted to be prior art. Where a conflict exists between the instant application and a reference provided herein, the instant application shall dominate.

What is claimed is:

1. A computer-implemented method, comprising:
capturing, by a camera of an activation computing device, an image containing a visual credential that is displayed on a screen of a credential computing device;
extracting, by the activation computing device, an activation link associated with a profile;
retrieving, by the activation computing device via the activation link, data associated with the profile from a profile database;
retrieving, by the activation computing device, a near-field communication (NFC) device identifier from a near-field communication (NFC) device; and
associating, by the activation computing device, the profile with the near-field communication (NFC) device identifier.

2. The method of claim 1 wherein the activation computing device associates the profile with the NFC device identifier by instructing the profile database to associate the profile to the near-field communication (NFC) device identifier in the profile database.

3. The method of claim 2, wherein the profile can be associated with one or more additional near-field communication (NFC) device identifiers.

4. The method of claim 1, wherein extracting the activation link associated with the profile comprises:
extracting information from the visual credential; and
translating the information from a first data format to a second data format.

5. The method of claim 4, wherein the profile is a first profile, the method further comprising:
transmitting, by the activation computing device, a request to the profile database for the profile database to associate the near-field communication (NFC) identifier to a second profile.

6. The method of claim 1, wherein the visual credential is at least one of a linear barcode or a matrix barcode.

7. The method of claim 1, wherein the activation computing device is a mobile device.

8. The method of claim 1, wherein the activation link is a deep link that identifies a location within a mobile application.

9. A non-transitory computer-readable medium storing a set of instructions, the set of instructions comprising:
one or more instructions that, when executed by one or more processors of an activation computing device, cause the activation computing device to:
capture an image containing a visual credential that is displayed on a screen of a credential computing device;
extract, from the visual credential, an activation link associated with a profile;
retrieve data associated with the profile from a profile database;
retrieve a near-field communication (NFC) device identifier from a near-field communication (NFC) device; and
associate the profile with the near-field communication (NFC) device identifier.

10. The non-transitory computer-readable medium of claim 9, wherein the one or more instructions that cause the activation computing device to extract the activation link associated with the profile cause the activation computing device to:
translate information comprising the activation link from a first data format to a second data format.

11. The non-transitory computer-readable medium of claim 10, wherein the one or more instructions, that cause the activation computing device to associate the profile, cause the activation computing device to:
read a unique identifier from the near-field communication (NFC) device; and
transmit a request for the profile database to associate the profile with the unique identifier, the request transmitted to the profile database.

12. The non-transitory computer-readable medium of claim 11, wherein the profile is a first profile and wherein the one or more instructions further cause the activation computing device to:
transmit a request for the profile database to associate the unique identifier with a second profile, the request transmitted to the profile database.

13. The non-transitory computer-readable medium of claim 9, wherein the visual credential is at least one of a linear barcode or a matrix barcode.

14. The non-transitory computer-readable medium of claim 9, wherein the activation link is a deep link that identifies a location within a mobile application.

15. An activation computing device, comprising:
one or more memories; and
one or more processors, communicatively coupled to the one or more memories, configured to:
capture an image containing a visual credential that is displayed on a screen of a credential computing device;
extract, from the visual credential, an activation link associated with a profile;
retrieve data associated with the profile from a profile database;
retrieve a near-field communication (NFC) device identifier from a near-field communication (NFC) device; and
associate the profile with the near-field communication (NFC) device identifier.

16. The activation computing device of claim 15, wherein the one or more processors, when extracting the activation link, are configured to:
translate information comprising the activation link from a first data format to a second data format.

17. The activation computing device of claim 15, wherein the one or more processors, when associating the profile, are configured to:
read a unique identifier from the near-field communication (NFC) device; and
transmit a request for the profile database to associate the profile with the unique identifier, the request transmitted to the profile database.

18. The activation computing device of claim 17, wherein the profile is a first profile and wherein the one or more processors are further configured to:
transmit a request for the profile database to associate the unique identifier with a second profile, the request transmitted to the profile database.

19. The activation computing device of claim 15, wherein the visual credential is at least one of a linear barcode or a matrix barcode.

20. The activation computing device of claim 15, wherein the activation link is a deep link that identifies a location within a mobile application.
